(19) United States
(12) Patent Application Publication
(10) Pub. No.: US 2012/0178275 A1
(43) Pub. Date: Jul. 12, 2012

(54) Power connector with a switch

(75) Inventors: Chun-Yu Shen, Kun Shan (CN); Jia-Yong He, Kun Shan (CN); Zhong-Hua Yao, Kun Shan (CN)

(73) Assignee: HON HAI PRECISION INDUSTRY CO., LTD.

(21) Appl. No.: 13/136,204

(22) Filed: Jul. 25, 2011

(30) Foreign Application Priority Data
Jul. 24, 2010 (CN) 201020269734.7

(51) Int. Cl. H01R 29/00

(52) U.S. Cl. 439/188

(57) ABSTRACT

A power connector includes an insulative housing, a power contact and a switch retained to the insulative housing. The insulative housing has a front surface, a first cavity and a second cavity recessed from the front surface. The power contact has a mating portion protruding into the first cavity. The switch has a button received in the second cavity and a connecting contact engaging with the button. The button has a lever protruding inwardly from an inner side thereof. The lever defines a through hole, and the connecting contact extends through the through hole and moves in the through hole in a pressing process of the button to make the connecting contact electrically connect or disconnect with the power contact.

### BACKGROUND OF THE INVENTION

1. Field of the Invention

The present invention relates to a power connector, and more particularly to power connectors with switches for controlling connecting status thereof.

2. Description of Related Art

Power connectors are widely used in electronic industry for transmitting power to electronic devices. As the security is paid more attention in nowadays, a kind of power connector with a switch is designed for meeting such requirement of people. China Patent CN2525702Y discloses such a power connector with a switch. The power connector includes a housing, a switch and an output contact assembled to the housing. The housing defines a first cavity to receive the switch and a second cavity to receive a power plug. The power connector has a power contact protruding into the second cavity to transmit power. The switch includes a button and a connecting contact connecting with the output contact. The button has a pressing portion on outside of the first cavity and a lever protruding into the first cavity. The lever resists an outside of the connecting contact.

When the power plug is inserted into the second cavity to be used, pressing the button, then the lever rotates to push a lower side the connecting contact backwardly to contact with the power contact. When the power plug is not used, pressing the button again, then the lever rotates to push an upper side of the connecting contact backwardly to make the connecting contact disengage with the power contact. However, the lever only presses the outside of the connecting contact to push the connecting contact rotating and does not fix with the connecting contact, when the lever pushes connecting contact, the connecting contact easily offsets to disengage with the lever, then the switch would not control the power connector to connect or disconnect with the power plug effectively.

Hence, an improved power connector is desired to overcome the above problems.

### BRIEF SUMMARY OF THE INVENTION

According to the present invention, a power connector comprises: an insulative housing, a power contact and a switch retained to the insulative housing. The insulative housing has a front surface, a first cavity and a second cavity recessed from the front surface. The power contact has a mating portion protruding into the first cavity. The switch has a button received in the second cavity and a connecting contact engaging with the button. The button has a lever protruding inwardly from an inner side thereof. The lever defines a through hole, and the connecting contact extends through the through hole and moves in the through hole in a pressing process of the button to make the connecting contact electrically connect or disconnect with the power contact.

According to another aspect of the present invention, a power connector comprises: an insulative housing, a power contact and a switch retained to the insulative housing. The insulative housing has a front surface, a first cavity and a second cavity recessed from the front surface. The power contact has a mating portion protruding into the first cavity. The switch has a button received in the second cavity and a connecting contact retained on the button. The connecting contact is driven to connect or disconnect with the power contact when the button is pressed.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a power connector according to the present invention;

FIG. 2 is a view similar to FIG. 1, while taken from another aspect;

FIG. 3 is a cross-sectional view of the power connector along line 3-3 shown in the FIG. 1, showing that a connecting contact thereof disconnects with a power contact thereof;

FIG. 4 is another cross-sectional view of the power connector, showing that the connecting contact thereof connects with the power contact thereof;

FIG. 5 is an exploded view of the power connector shown in FIG. 1; and

FIG. 6 is a view similar to FIG. 5, while taken from another aspect.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

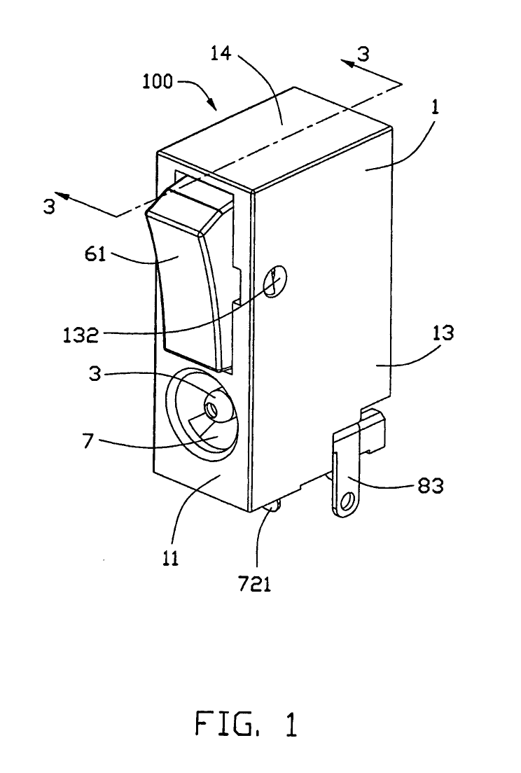

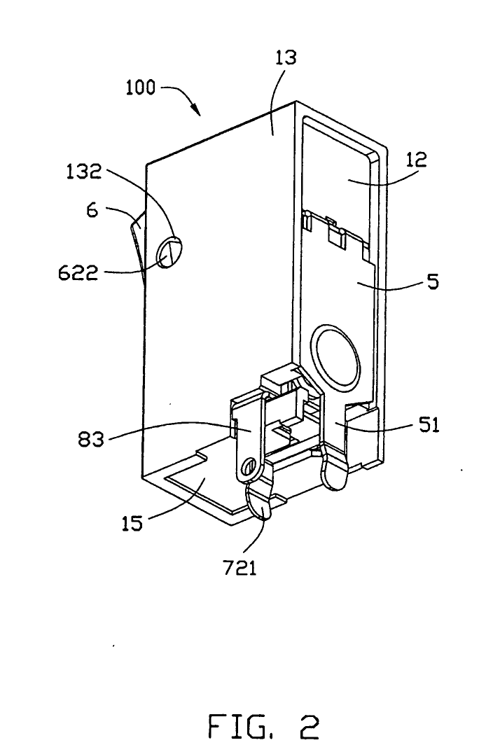

Referring to FIGS. 1-3 and 5, a power connector 100 according to the present invention is disclosed. The power connector 100 comprises an insulative housing 1, a switch and an output contact 5 retained on an upper side of the insulative housing 1, a power contact 3 and a pair of detect terminals retained on a lower side of the insulative housing 1. The switch comprises a button 6 and a connecting contact 4 engaging with the button 6. The detect terminals comprise a stationary first contact 8 and a flexible second contact 7 to contact with the first contact 8 along an up to down direction.

Referring to FIGS. 1-6, the insulative housing 1 has a front surface 11, a rear surface 12, a pair of side walls 13, a top surface 14 and a bottom surface 15. The insulative housing 1 defines a first cavity 110 and a second cavity 111 respectively recessed from the front surface 11, and a partition board 16 between the first cavity 110 and the second cavity 111 along the up to down direction. The first cavity 110 is located below the second cavity 111. The partition board 16 defines a position slot 161 recessed from a rear end thereof. The position slot 161 has a level slot 161a and a vertical slot 161b communicating with the level slot 161a along the up to down direction. The insulative housing 1 defines a position hole 18 extending therethrough along a front to back direction perpendicular to the up to down direction. The position hole 18 is located behind the first cavity 110 and communicates with the first cavity 110 along the front to back direction.

The insulative housing 1 is formed with a first limiting wall 121 at an upper side of the second cavity 111 and a second limiting wall 162 at a lower side of the second cavity 111. The first limiting wall 121 and the second limiting wall 162 align to each other along the up to down direction. The insulative housing 1 defines a pair of second axle holes 132 at two side walls 13. The slots 132 communicate with the second cavity 111 along a transverse direction perpendicular to the up to down direction and the front to back direction. Each side wall 13 further defines a slot 1321 extending along the front to back direction and a first axle hole 1322 at a rear end of the slot 1321. The slot 1321 and the first axle hole 1322 communicate with the second cavity 111 along the transverse direction. The second axle holes 132 are located at a front side of the slots 1321 and communicate with the slots 1321. The insulative housing 1 further defines a first retaining slot 131 recessed from the rear surface thereof and located below the first cavity 110, a second retaining slot 133 at an upper side of the first retaining slot 131, and a fixing slot 123 recessed from the rear surface 12 thereof and communicating with the second cavity 111 along the front to back direction. The second retaining slot 133 is located below the first cavity 110 and communicates with the first cavity 110 and the first retaining slot 131 along the up to down direction.

Referring to FIGS. 1-6, the connecting contact 4 is assembled into the second cavity 111 from a front side of the insulative housing 1 along the slot 1321. The connecting contact 4 has a first arm 41 extending along the up to down direction and a second arm 42 bending downwardly from a top end of the first arm 41. The first arm 41 has a stopping portion 411 at a lower end thereof. The second arm 42 has a pair of second pivots 423 at two sides thereof, a fixing portion 4232 between the second pivots 423, and a first connecting portion 421 at a lower end thereof. The second pivots 423 are received in the first axle holes 1322 and can rotate in the first axle holes 1322. The output contact 5 has a horizontal retaining portion 52 retained in the fixing slot 123, a joint portion 5211 forwardly protruding into the second cavity 111 to connect with the fixing portion 4232, and a tail portion 51 downwardly extending out of the insulative housing 1 to connect with a circuit board (not shown).

The button 6 has a pressing portion 61 and a lever 62 backwardly extending from an inner side of the pressing portion 61. The pressing portion 61 is located at a front position of the second cavity 111 and protrudes out of the front surface 11. The pressing portion 61 is formed with a pair of second pivots 622 outwardly protruding from two sides thereof to engage with the second axle holes 132 of the insulative housing 1. The second pivots 622 can rotate in the second axle holes 132 when the pressing portion 61 is pressed. The lever 62 defines a through hole 621 extending therethrough along the up to down direction. The first arm 41 passes through the through hole 621 and can moves in the through hole 621. The stopping portion 411 is located at a lower side of the through hole 621 to prevent the first arm 41 from escaping from the through hole 621.

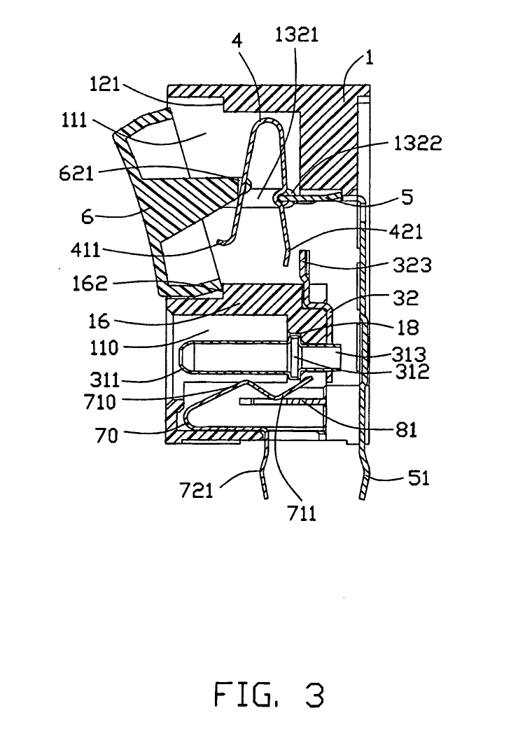

Referring to FIGS. 3-6, the power contact 3 has a middle contact 31 and a transfer contact 32 connecting a rear end of the middle contact 31. The middle contact 31 has a securing portion 312 retained in the position hole 18, a mating portion 311 forwardly extending into the first cavity 110 to connect with a power plug (not shown), and a rear end 313 to connect with the transfer contact 32. The transfer contact 32 has a horizontal middle portion 322 retained in the level slot 161a, a second connecting portion 323 upwardly bending from a front end of the middle portion 322 to connect with the first connecting portion 421 of the connecting contact 4, and a lower portion 321 downwardly bending from a rear end of the middle portion 322 to fix with the rear end 313 of the middle contact 31. The second connecting portion 323 passes through the vertical slot 161b and protrudes into the second cavity 111.

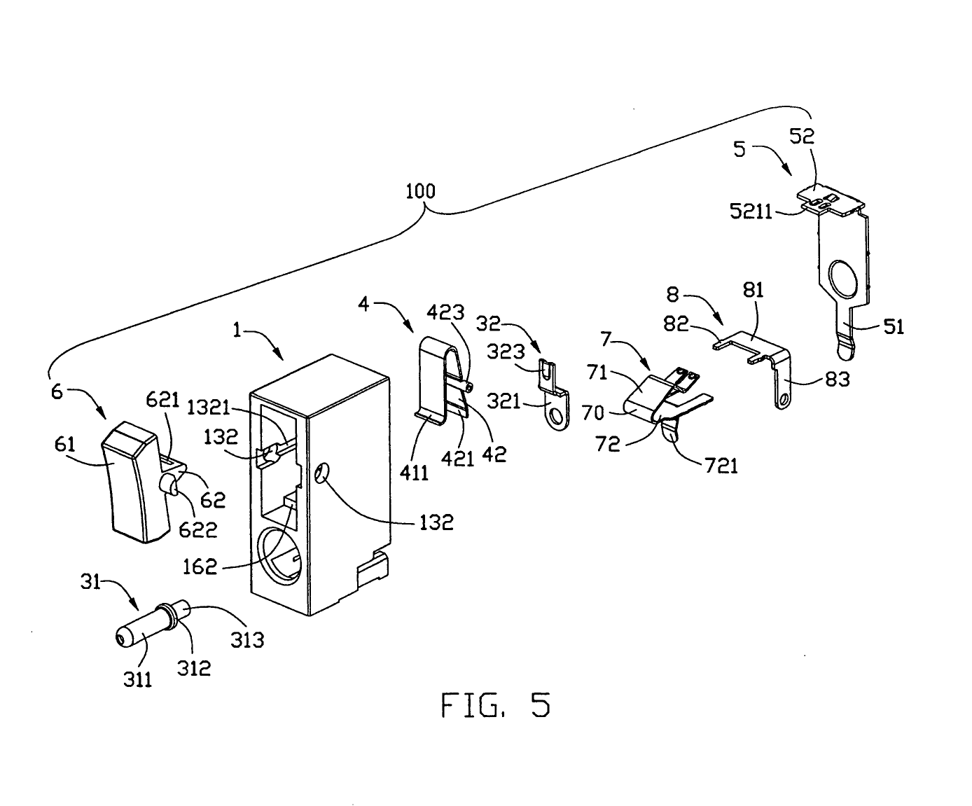

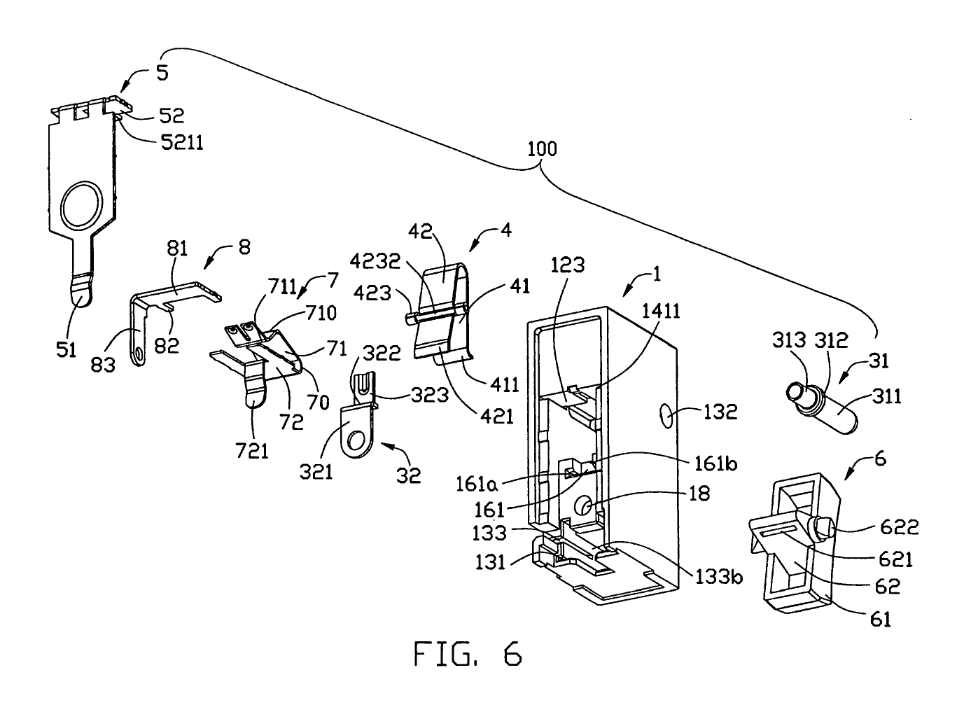

Referring to FIGS. 5 and 6, the first terminal 8 has a horizontal portion retained in the first retaining slot 131 and a tail portion 83 extending out of the insulative housing 1. The horizontal portion has a pair of retaining arms 82 retained in the first retaining slot 131 and a first detecting portion 81 between the retaining arms 82 and upwardly exposed to the second retaining slot 133. The second contact 7 has a front end 70, a spring arm 71 and a base 72 extending backwardly from the front end 70, and a soldering portion 721 extending out of the insulative housing 1 from the base 72. The spring arm 71 is formed with a mating portion 710 upwardly protruding into the first cavity 110, and a second detecting portion 711 downwardly extending form a rear end of the mating portion 710. The second detecting portion 711 and the first detecting portion 81 align to each other along the up to down direction. When the power plug is inserted into the first cavity 110, the second detecting portion 711 is pressed downwardly to electrically connect with the first detecting portion 81. The base 72 is formed with a plurality of ribs at two sides thereof to engage with the second retaining slot 133.

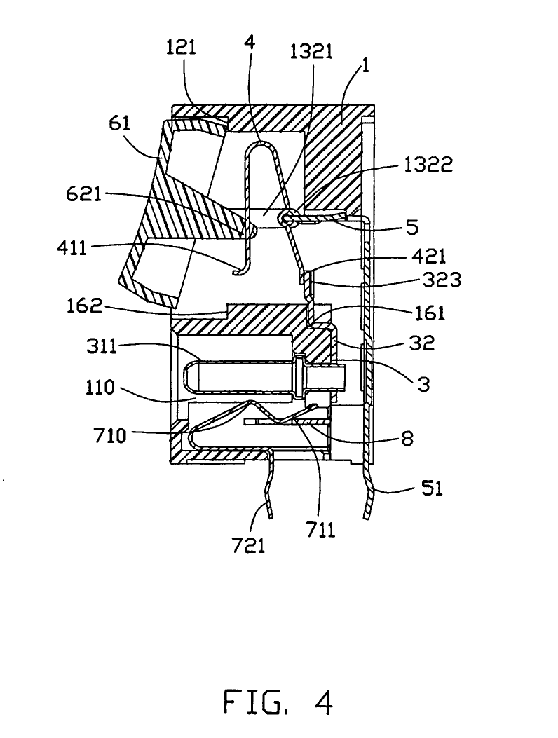

Referring to FIGS. 3-4, when the power plug is inserted into the power connector 100 of the present invention, pressing an upper side of the pressing portion 61 of the button 6 to make the upper side resist the first limiting wall 121, the lever 62 rotates downwardly to resist a lower side of the first arm 41 backwardly, and the connecting contact 4 rotates around the first pivots 423 along an anticlockwise direction to make the first connecting portion 421 move backwardly to connect with the second connecting portion 323 of the transfer contact 32, then the middle contact 31, the transfer contact 32, the connecting contact 4 and the output contact 5 electrically connect to form an electrical path for transmitting power to the circuit board.

When the power plug is not in using, pressing a lower side of the button 6 backwardly to make the lower side resist the second limiting wall 162, the lever 62 rotates upwardly to resist an upper side of the first arm 41 backwardly, and the connecting contact 4 rotates around the first pivots 423 along an clockwise direction to make the first connecting portion 421 move forwardly to disengage with the second connecting portion 323, then the power contact 3 does not electrically connect with the output contact 5, and the power connector 100 can not transmit power to the circuit board.

As fully described above, the connecting contact 4 in the present invention is movably retained to the button 6, which can make the connecting contact 4 always engage with the button 6, and the connecting contact 4 can not offset to disengage with the button 6, then the power connector 100 in the present invention will have a long life and can effectively control the power connector 100 to connect or disconnect with the power plug.

Of course, the connecting contact 4 can be alternatively fixed to the button 6 and can not move relative to the button 6, then the connecting contact 4 can be driven to connect or disconnect with the power contact 3 by the button 6, which can achieve the above purpose of the present invention.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A power connector, comprising:
an insulative housing having a front surface, a first cavity and a second cavity recessed from the front surface;
a power contact retained to the insulative housing, the power contact having a mating portion protruding into the first cavity; and
a switch retained on the insulative housing, the switch having a button received in the second cavity and a connecting contact engaging with the button, the button having a lever protruding inwardly from an inner side thereof;
wherein the lever defines a through hole, and the connecting contact extends through the through hole and moves in the through hole in a pressing process of the button to make the connecting contact electrically connect or disconnect with the power contact.

2. The power connector according to claim 1, wherein the through hole extends through the lever along an up to down direction, and the connecting contact has a first arm extending along the up to down direction and a second arm bending downwardly from a top end of the first arm, and the first arm passes through the through hole.

3. The power connector according to claim 2, wherein the first arm has a stopping portion at a lower end thereof to prevent the first arm from escaping from the through hole.

4. The power connector according to claim 2, wherein the second arm is formed with a pair of first pivots at two sides thereof, and the insulative housing defines a pair of first axle holes to engage with the pivots.

5. The power connector according to claim 4, wherein the second arm has a first connecting portion at a lower end thereof to connect with the power contact.

6. The power connector according to claim 5, wherein the power contact has a middle contact and a transfer contact connecting a rear end of the middle contact, and the mating portion is formed at a front side of the middle contact, and the transfer contact extends along the up to down direction to contact with the first connecting portion of the second arm.

7. The power connector according to claim 1, further comprising an output contact retained on the insulative housing, the output contact has a joint portion electrically connecting with the connecting contact and a tail portion extending out of the insulative housing to connect with a circuit board.

8. The power connector according to claim 1, wherein the button has a pressing portion with a pair of second pivots at two sides thereof, and the insulative housing defines a pair of second axle holes at two sides of the second cavity to engage with the second pivots respectively, the second pivots are located at front of the first pivots.

9. A power connector, comprising:
an insulative housing having a front surface, a first cavity and a second cavity recessed from the front surface;
a power contact retained to the insulative housing, and the power contact having a mating portion protruding into the first cavity; and
a switch retained on the insulative housing, the switch having a button received in the second cavity and a connecting contact retained on the button;
wherein the connecting contact is driven to connect or disconnect with the power contact when the button is pressed.

10. The power connector according to claim 9, wherein the button has a pressing portion forwardly protruding out of the second cavity and a lever protruding inwardly from an inner side of the pressing portion, and the connecting contact has a first arm retained on the lever and a second arm bending from the first arm to connect or disconnect with the power contact.

11. The power connector according to claim 10, wherein the pressing portion is formed with a pair of second pivots at two sides thereof, and the insulative housing defines a pair of second axle holes at two sides of the second cavity to engage with the second pivots respectively.

12. The power connector according to claim 10, wherein the second arm has a first connecting portion at a lower end thereof to connect with the power contact.

13. The power connector according to claim 12, wherein the power contact has a middle contact and a transfer contact connecting a rear end of the middle contact, and the mating portion is formed at a front side of the middle contact, and the transfer contact extends along the up to down direction to contact with the first connecting portion of the second arm.

14. The power connector according to claim 9, further comprising a output contact retained on the insulative housing, the output contact has a joint portion electrically connecting with the connecting contact and a tail portion extending out of the insulative housing to connect with a circuit board.

15. A power connector comprising:
an insulative housing defining a first receiving cavity and a second receiving cavity;
a power contact disposed in the housing and exposed in the first receiving cavity;
a stationary detect terminal and a flexible detect terminal disposed in the housing around the first receiving cavity, both of said stationary detect terminal and said flexible detect terminal having tails for connecting to an exterior;
a switch moveably mounted to the housing and moveable in the second receiving cavity; and
an output contact disposed in the housing around the second receiving cavity and connecting to the exterior; wherein
said switch includes a moveable connecting contact having a first portion constantly connected to one of the output contact and the power contact, and a second portion moveable between an open position and a closed position with regard to the other of the output contact and the power contact.

16. The power contact as claimed in claim 15, wherein the first portion is constantly connected to the output contact, and the second portion is moveable between the open position and the closed position with regard to the power contact.

17. The power contact as claimed in claim 15, wherein the flexible detect terminal is disconnected from the stationary detect terminal when no power plug is inserted into the first receiving cavity to connect to the power contact, while is moved toward and connected with the stationary detect terminal when the power plug is inserted into the first receiving cavity and contacts the power contact.

18. The power contact as claimed in claim 15, wherein the flexible detect terminal further cooperate with the output contact to form a complete circuit loop for the inserted power plug.

19. The power contact as claimed in claim 15, wherein the connecting contact defines first and second arms under condition that the first arm includes the first portion and the second portion, and the second arm is constantly linked to a press button of the switch.

20. The power contact as claimed in claim 19, wherein said press button is pivotally mounted to the housing, and the first arm is pivotally mounted to the output contact.
